(19) United States
(12) Patent Application Publication
(10) Pub. No.: US 2022/0336865 A1
(43) Pub. Date: Oct. 20, 2022

(54) MAGNESIUM-CARBON BATTERY

(71) Applicant: GYFT Labs Inc., Beaverton, OR (US)

(72) Inventor: Gordan Wolfer, St. Helens, OR (US)

(73) Assignee: GYFT Labs Inc., Beaverton, OR (US)

(21) Appl. No.: 17/721,267

(22) Filed: Apr. 14, 2022

Related U.S. Application Data
(60) Provisional application No. 63/175,515, filed on Apr. 15, 2021.

(51) Int. Cl. H01M 10/36; H01M 4/583; H01M 4/38

(52) U.S. Cl. CPC H01M 10/36; H01M 4/583; H01M 4/38; H01M 10/0569

(57) ABSTRACT

An apparatus for a rechargeable battery is disclosed. The battery includes an anode including magnesium, a cathode including carbon, an electrolyte solution including water, and an amino acid. The electrolyte solution may further include a mixture of alkali, and alkaline earth metal salts, and the amino acid may be configured to have a chelating effect on one or more of alkali, and alkaline earth metal ions in the electrolyte solution.

### CROSS-REFERENCES

This application claims the benefit under 35 U.S.C. § 119(e) of the priority of U.S. Provisional Patent Application Ser. No. 63/175,515, filed Apr. 15, 2021, the entirety of which is hereby incorporated by reference for all purposes.

### FIELD

This disclosure relates to systems and methods for rechargeable batteries. More specifically, the disclosed examples relate to compositions of aqueous electrolytes for magnesium battery systems, and methods for activating such battery systems.

### INTRODUCTION

Currently, lithium-ion batteries are highly sought after as sustainable and portable power sources. However, lithium battery fabrication is dependent on limited availability of lithium resources. Magnesium batteries offer a promising alternative technology. Magnesium metal is an attractive anode material by virtue of its high natural abundance, and divalent characteristics. An appropriate cathode and an electrolyte component matched with a magnesium anode can significantly influence electrochemical characteristics, power outputs, stability, and rechargeability of the magnesium batteries.

Organometallic reagents in various solvents have been used primarily as non-aqueous electrolytes for magnesium batteries. Non-aqueous electrolytes may result in less resistance against reduction by a magnesium anode, but may also contribute to lower conductivity and electrochemical stability values on the cathode surface. Moreover, non-aqueous electrolytes may be extremely moisture sensitive, and therefore need to be prepared and used instantaneously following stringent protocols. In contrast, aqueous electrolytes offer low-cost, non-corrosive, safe, and highly conductive alternatives for magnesium battery systems.

### SUMMARY

The present disclosure provides systems, apparatus, and methods relating to rechargeable magnesium carbon battery systems. In some examples, an apparatus for a battery may include an anode including magnesium, and a cathode including carbon. The apparatus may include an electrolyte solution including water, and an amino acid.

In some examples, a kit for a battery, includes a battery, the battery may include an anode including magnesium, and a cathode including carbon. The kit may include an electrolyte mixture in a container separate from the battery, and formulated to activate the battery. The electrolyte solution may be provided in an aqueous solution, or in a dry form, along with instructions for hydrating the electrolyte mixture prior to activating the battery. The kit may have multiple aliquots of electrolyte for sequential battery activation steps.

In some examples, a method for activating a battery, may include storing a dry pre-activated battery including an anode including magnesium, and a cathode including carbon. The method may include activating the battery by adding an electrolyte solution comprising an amino acid.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a schematic diagram of an illustrative battery system, including an anode, cathode, and electrolyte, in accordance with aspects of the present disclosure.

FIGS. 2A-2B are diagrams of an illustrative chemical composition of an electrolyte component of the battery system of FIG. 1.

FIG. 3 is a schematic diagram of a battery kit for activation of the battery system of FIG. 1.

FIG. 4 is a flow diagram depicting steps in an illustrative method of activating the battery system of FIG. 1.

### DETAILED DESCRIPTION

Various aspects and examples of magnesium carbon batteries, including aqueous electrolyte systems, as well as related apparatus and methods, are described below and illustrated in the associated drawings. Unless otherwise specified, such an apparatus and/or its various components may, but are not required to, contain at least one of the structures, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or its uses. Additionally, the advantages provided by the examples and embodiments described below are illustrative in nature, and not all examples and embodiments provide the same advantages or the same degree of advantages.

This Detailed Description includes the following sections, which follow immediately below: (1) Overview; (2) Examples, Components, and Alternatives; (3) Illustrative Combinations and Additional Examples; (4) Advantages, Features, and Benefits; and (5) Conclusion. The Examples, Components, and Alternatives section is further divided into subsections A, B, and C, each of which is labeled accordingly.

### Definitions

The following definitions apply herein, unless otherwise indicated.

“Substantially” means to be more-or-less conforming to the particular chemical structure, dimension, range, shape, concept, or other aspect modified by the term, such that a feature or component need not conform exactly. For example, “a chemical structure substantially having Nitrogen (N), and Oxygen (O) donor groups” means that the structure may include one or more functional groups having N and O, for example, amines, acids, alcohols, phenols, aldehydes, ketones, amides and the like.

“Comprising,” “including,” and “having” (and conjugations thereof) are used interchangeably to mean including but not necessarily limited to, and are open-ended terms not intended to exclude additional, unrecited elements or method steps.

### Overview

In general, an apparatus for a rechargeable battery includes a magnesium anode, a carbon cathode, and an aqueous solution of an amino acid as an electrolyte. The electrolyte solution also includes salts of alkali, and alkaline earth metals, like lithium, sodium, and magnesium. The amino acid is configured to have a chelating effect on one or more of lithium, sodium, or magnesium ions in the electrolyte to promote higher efficiency, power output, and extended time between recharges for the battery.

A battery kit, including the battery, is portable to facilitate quick, and easy serial activation of the battery to continuously power electrical or electronic devices on the go. The battery kit also includes one or more packets of anhydrous electrolyte mixture, an electrolyte solvent, an activation brochure, and an accessories packet for quick, and easy battery activation. The activation brochure includes step-by-step method instructions for activation of the battery. The brochure highlights a specific order for the addition of electrolyte components, mixing time in electrolyte solvent, pre-specified amounts of electrolyte components, and cautionary instructions for handling activation of the battery.

### Examples, Components, and Alternatives

The following sections describe selected aspects of an exemplary magnesium-carbon battery as well as related systems and/or methods. The examples in these sections are intended for illustration and should not be interpreted as limiting the entire scope of the present disclosure. Each section may include one or more distinct examples, and/or contextual or related information, function, and/or structure.

A. Illustrative Apparatus for Magnesium Carbon Battery

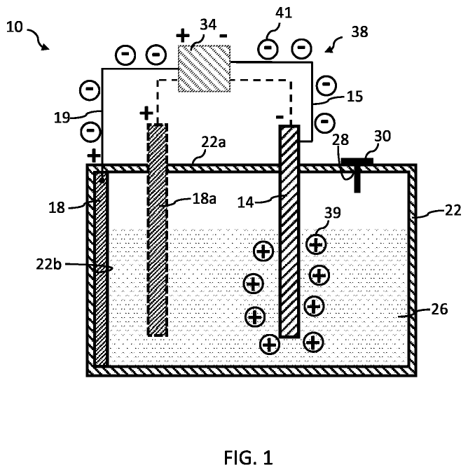

As shown in FIG. 1, battery apparatus 10 is an example of a magnesium battery system. Battery apparatus 10 includes an anode 14, and a cathode 18, housed in a battery casing 22. Anode 14 may be removably inserted into a top portion 22a of battery casing 22. Cathode 18 may be positioned along an inner sidewall 22b of battery casing 22, or vice-versa. Alternatively, cathode 18a may be removably inserted into top portion 22a of battery casing 22, similar to anode 14. An electrolyte 26 may be introduced into battery casing 22 through an aperture 28, located on top portion 22a of battery casing 22. Additionally, aperture 28 may receive a removably insertable lid member 30. Battery casing 22 is configured to securely hold anode 14, cathode 18, and electrolyte 26 in an air-tight manner during the operational use of battery apparatus 10. Battery casing 22 can be made of plastic, steel, soft polymer laminates, or any other suitable material.

In the present example, as shown in FIG. 1, anode 14 includes magnesium metal, and cathode 18 includes activated carbon, for example, in the form of graphite. In the example illustrated in FIG. 1, a single cell or unitary battery is illustrated, but two or more such batteries may be connected in series or parallel connection to generate the desired Electro-Motive Force (EMF).

An anode lead wire 15 attached to anode 14, and a cathode lead wire 19 attached to cathode 18, may be connected to an electrical or electronic device 34 to form an external circuit 38. It may be noted that a similar external circuit may be envisaged for anode 15 and cathode 18a. Importantly, in the presence of electrolyte 26, one or more chemical reactions may occur at anode 14, and cathode 18, when connected to device 34 via external circuit 38. An oxidation reaction occurs between anode 14 and electrolyte 26 to produce positive ions 39, and electrons 41. A reduction reaction occurs in or near cathode 18, whereby electrons 41 produced by the oxidation reaction at anode 14 are consumed during reduction. Movement of positive ions 39 in electrolyte 26 is allowed, but a movement of electrons 41 through electrolyte 26 is inhibited. As a result, electrons 41 are forced to flow from anode 14 to cathode 18 through external circuit 38, thus providing power to device 34.

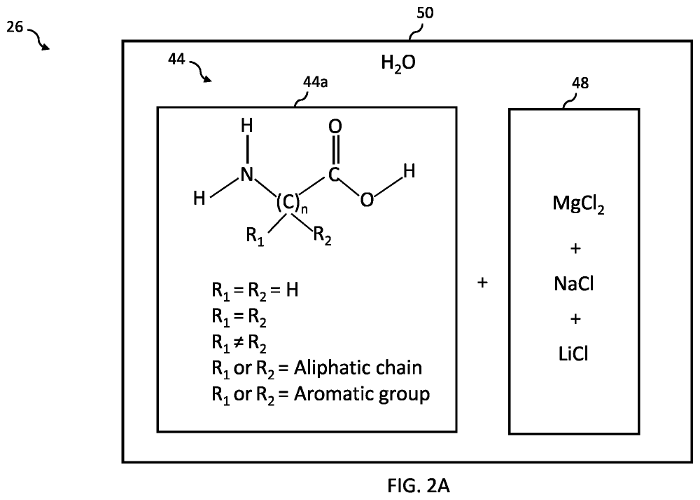

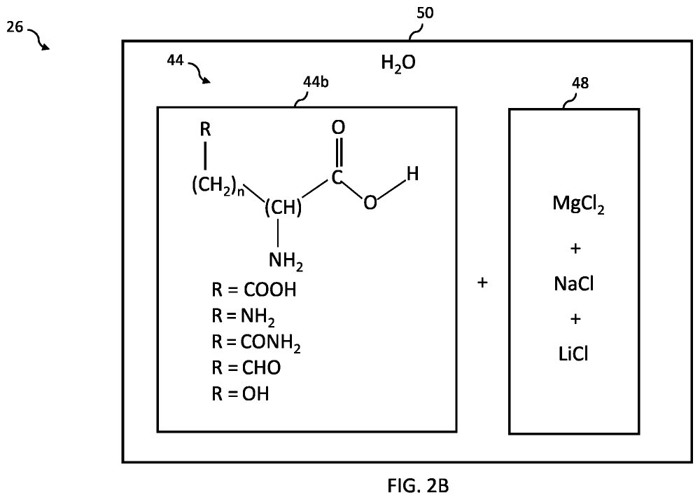

Notably, a composition of electrolyte 26 is crucial to achieve desired efficiencies, high power outputs, and to extend time periods between recharging steps for battery 10. In other words, electrolyte 26 needs to be formulated so as to provide less resistance for chemical reactions at anode 14 and cathode 18, so that electrons are allowed to flow smoothly, and higher power output is achieved. As illustrated in FIGS. 2A and 2B, electrolyte 26 includes a combination of a chelating agent 44 and a mixture of alkali, and alkaline earth metal halides 48, in an aqueous solution or water 50. In an example illustrated in FIG. 2A, chelating agent 44a includes an organic amino acid compound with the general structural formula (NH₂)—(CR₁R₂)ₙ—COOH. A mixture of alkali and alkaline earth metal halides 48 includes salts of magnesium, sodium, and lithium, for example, magnesium chloride, sodium chloride, and lithium chloride.

Examples of chelating agents 44a may include essential amino acids—Histidine (His), Isoleucine (Ile), Leucine (Leu), Lysine (Lys), Methionine (Met), Phenylalanine (Phe), Threonine (Thr), conditionally essential amino acids—Arginine (Arg), Cysteine (Cys), Glutamine (Gin), Glycine (Gly), Proline (Pro), Serine (Ser), Tyrosine (Tyr), Tryptophan (Trp), Valine (Val), non-essential amino acids—Alanine (Ala), Asparagine (Asn), Aspartic acid (Asp), Glutamic acid (Glu), Selenocysteine (Sec), among others. Other examples include amino acids, including an aliphatic carbon chain, when R₁=R₂ or R₁−R₂=H in the general structural formula as mentioned above. In yet other examples R₁ or R₂ may include aromatic groups, which may enhance electronic charge delocalization upon chelation with magnesium, lithium, or sodium ions. In yet other examples R₁ may be different from R₂, leading to chiral aliphatic or aromatic amino acids, whereby a spatial structural configuration of enantiomers or diastereomers may play a significant role in forming coordination complexes with magnesium, lithium, or sodium ions.

Similarly, as in an example illustrated in FIG. 2B, chelating agent 44b may include an organic amino acid compound with the general structural formula (NH₂)—(CH—(CH₂)ₙ—R)—COOH, and a mixture of alkali, and alkaline earth metal halides 48. Side chain R-group may include branched aliphatic chains, including double or triple bonds, and carboxylic acid, amine, amide, aldehyde, or alcohol end groups. Examples may include amino dicarboxylic acids, diamino carboxylic acids, alcoholic or phenolic amino acids, amino acids with side chain(s) having amide end groups, and the like. A length of an aliphatic carbon chain may be preferably between 9-11 carbons to conform to a desired spatial configuration.

Chelating agent 44 includes Nitrogen (N) of amino group (NH2), and Oxygen (O) of carboxylic, alcohol, phenol, ketone or aldehyde groups as active entities. The active entities on chelating agent 44 act as end effectors or claws to encapsulate magnesium, lithium or sodium ions to form coordination complexes in aqueous electrolyte 26. The coordination complexes are completely soluble in aqueous electrolyte 26 to facilitate smooth movement of positive ions 39 through electrolyte 26, and electrons 41 through external circuit 38, to provide power to device 34.

Chelating agent 44, including the active entities as end effectors, offers convenient handles for generating polypeptides, whereby a three-dimensional spatial configuration of a polypeptide can be controlled to achieve a desired chelating effect. Additionally, functional groups R, R₁, and R₂ can be systematically varied to control the effect of side chains on a chelating effect of a chelating agent on alkali and alkaline earth metal ions in electrolyte 26. Overall, electrolyte 26, including chelating agent 44, has a positive effect in enhancing power output, and extending time periods between recharging steps for battery apparatus 10.

Referring to FIGS. 1 and 2, in an exemplary embodiment, battery apparatus 10 includes electrodes 14, 18, and electrolyte 26 with details as mentioned below. Specifically, battery apparatus 10, includes magnesium metal as anode 14, activated carbon (graphite) as cathode 18, and a mixture of lithium chloride, sodium chloride, magnesium chloride, and glutamic acid stabilized in water, as electrolyte 26.

Electrodes: Mg(s)|Mg²⁺(aq)∥H2(g)|C(s,Graphite)

Electrolyte: LiCl(aq),Nacl(aq),MgCl₂(aq),C₅H₁₀ClNO₄(aq)

Reaction: Mg(s)+2H⁺(aq)→Mg²⁺(aq)+H₂(g)

The oxidation reaction which occurs at anode 14 is as described above. Magnesium anode 14 in the presence of electrolyte 26 produces Mg²⁺ (positive ions 39), and electrons 41. Electrolyte 26 facilitates movement of positive ions 39 through electrolyte 26 but forces movement of electrons 41 through external circuit 38, thereby powering device 34. A preferred composition for electrolyte 26 is as detailed in Table-1 below:

TABLE 1

| S. N | Component name | Formula | Weight % |
|---|---|---|---|
| 1. | Lithium chloride | LiCl | 1%-11% |
| 2. | Sodium chloride | NaCl | 1%-9% |
| 3. | Magnesium chloride | MgCl₂ | 1%-6% |
| 4. | Glutamic acid | C₅H₁₀ClNO₄ | 0%-11% |
| 5. | Water | H₂O | 68%-94% |

Notably, a preferred composition of electrolyte 26 includes, lithium chloride in a range of 1%-11% by weight % sodium chloride in a range of 1%-9% by weight %, magnesium chloride in a range of 1%-6% by weight %, glutamic acid of up to 11% by weight %, stabilized in 68%-94% by weight % of water. A preferred order of addition of electrolyte components for preparing electrolyte 26 includes the addition of magnesium chloride, sodium chloride in pre-specified quantities, followed by addition of glutamic acid and lithium chloride in pre-specified quantities, to a pre-specified amount of water, and stirring continuously until all components are completely dissolved to provide a solution of electrolyte 26.

B. Illustrative Kit for Magnesium Carbon Battery

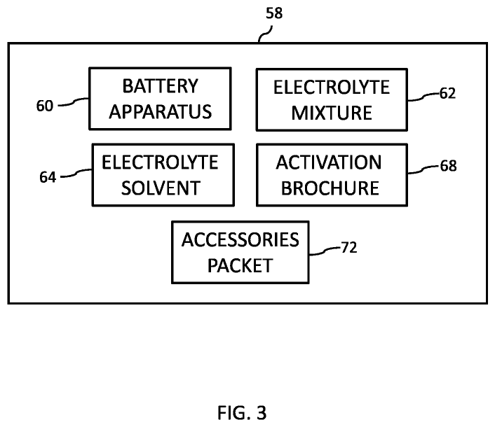

FIG. 3 is a schematic diagram of a battery kit 58, including a battery apparatus 60, one or more electrolyte mixture packets 62, an electrolyte solvent 64, an activation brochure 68, and an accessories packet 72 for activation of battery apparatus 60. Battery kit 58 may be portable to facilitate quick and easy serial activation of battery apparatus 60 to continuously power device 34 on the go.

Battery apparatus 60 of battery kit 58 may be similar in structure and configuration to battery apparatus 10 described above. Battery apparatus 60 may include an anode 14, including magnesium, and a cathode 18, including activated carbon. Battery apparatus 60 may include a single cell or unit of a battery or a battery system including two or more such batteries connected in series or parallel connections to generate an E.M.F. for the desired application. Specifically, anode 14 and cathode 18 of battery apparatus 60 may have specialized anti-corrosion coatings or coverings to avoid corrosion upon exposure to an ambient environment, and battery apparatus 60 may be stored in special containers, compartments, or pouches to preserve its chemical configuration.

Electrolyte mixture 62 of battery kit 58 may include electrolyte components in discreet packets or pouches, separate from battery apparatus 60, and formulated to activate battery apparatus 60. Optionally, electrolyte mixture 62 may be contained in a plurality of packets formulated for serial activation of battery apparatus 60 over an extended time period. Electrolyte mixture 62 may include an amino acid or chelating agent 44, and may be stabilized in a dehydrated form until activation of battery apparatus 60 is desired. In an example, electrolyte mixture 62 may include glutamic acid as chelating agent 44, in an amount configured for hydration to a concentration of up to 11% by weight. Furthermore, electrolyte mixture 62 may include lithium chloride in an amount configured for hydration to a concentration in a range of 1% to 11% by weight. Furthermore, electrolyte mixture 62 may include sodium chloride in an amount configured for hydration to a concentration in a range of 1% to 9% by weight. Furthermore, electrolyte mixture 62 may include magnesium chloride in an amount configured for hydration to a concentration in a range of 1% to 6% by weight.

Electrolyte solvent 64 of battery kit 58 may include primarily water 50 in a container separate from battery apparatus 60. The water may be deionized and stored in a pre-specified amount configured for hydration of a pre-specified amount of electrolyte mixture 62. The container may be configured to store a pre-specified amount of water in an environment to avoid evaporation of water over an extended period of time.

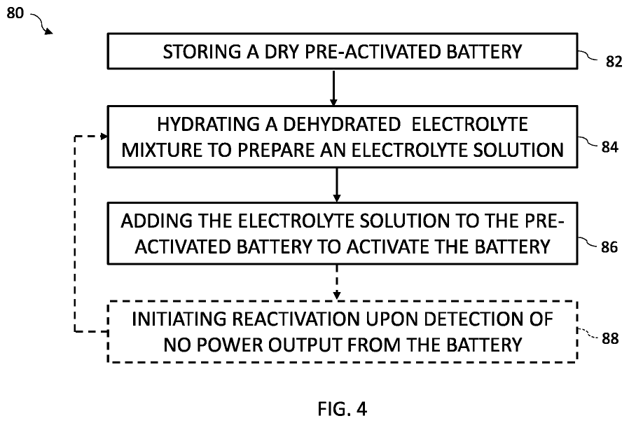

Activation brochure 68 of battery kit 58 may include step-by-step instructions for activation of battery apparatus 60, as detailed later in reference to FIG. 4. Activation brochure 68 may also include details of a specific order for addition of electrolyte components, mixing time in electrolyte solvent 64, pre-specified amounts of electrolyte components, and cautionary instructions for handling activation of battery apparatus 60.

Accessories packet or pouch 72 of battery kit 58 may include one or more spare containers for mixing electrolyte mixture 62 in electrolyte solvent 64 to prepare electrolyte 26. Additionally, accessories packet 72 may include electrolyte injection instruments for precisely withdrawing a pre-specified amount of prepared electrolyte 26, and injecting the same into battery apparatus 60.

C. Illustrative Method for Activating a Magnesium Carbon Battery

This section describes the steps of an illustrative method 80 for activating a magnesium battery. As shown in FIG. 4, aspects of battery apparatus 10, and battery kit 58, including battery apparatus 60 may be utilized in the method steps described below. Where appropriate, reference may be made to components and systems that may be used in carrying out each step. These references are for illustration, and are not intended to limit the possible ways of carrying out any particular step of the method.

FIG. 4 is a flowchart illustrating steps performed in an illustrative method 80, and may not recite the complete process or all steps of the method. Although various steps of method 80 are described below and depicted in FIG. 4, the steps need not necessarily all be performed, and in some cases, may be performed simultaneously or in a different order than the order shown.

At step 82, method 80 includes storing dry pre-activated batteries 10, 60. Batteries 10, 60 may include an anode 14 including magnesium, and a cathode 18 including activated carbon. Each of anode 14 and cathode 18 may have coatings to preserve their chemical configuration upon exposure to an ambient environment. Batteries 10, 60 may be stored in containers or pouches configured to maintain a dry environment to preserve an original structure and configuration.

At step 84, method 80 includes hydrating a dehydrated electrolyte mixture to prepare an electrolyte solution 26. Step 84 may include adding a pre-specified amount of magnesium chloride to a pre-specified amount of type I deionized (Ultrapure) water and stirring the mixture. Type I water is defined by the American Society for Testing and Materials (ASTM) as having a resistivity of >18 MΩ-cm, a conductivity of <0.056 μS/cm, and <50 ppb of Total Organic Carbons (TOC). Next, step 84 may include adding a pre-specified amount of sodium chloride to the stirred mixture, and further stirring the mixture. Next, step 84 may include adding a pre-specified amount of amino acid or chelating agent 44 to the stirred mixture, and further stirring the mixture. Lastly, step 84 may include adding a pre-specified amount of lithium chloride to the stirred mixture, and further stirring the mixture at room temperature until all the electrolyte components are completely dissolved.

At step 86, method 80 includes activating batteries 10, 60, by adding a pre-specified amount of the electrolyte solution 26 prepared in step 84, to batteries 10, 60. A pre-specified amount of the electrolyte solution 26 may be withdrawn from the prepared electrolyte solution 26, and injected into batteries 10, 60 by using injection accessories 72 mentioned above.

The electrolyte compositions, as noted above, are added to batteries 10, 60. The amount added to each battery may vary over a wide range depending upon the type, size, dimension, age of the battery, and desired results. For example, when employing electrolyte 26, as prepared above, one preferably adds about 0.5 to 2 ml of electrolyte 26 to each standard AA battery type. After electrolyte 26 has been added to batteries 10, 60, the batteries may then be put into operation by connecting to an electrical or electronic device or by employing in an automobile as a power source, as the effect of the electrolyte appears almost instantaneously.

For some batteries, 10, 60 multiple activations may be desirable. A standard AA battery type can be reactivated up to three times without compromising efficiency and power output. At step 88, optionally method 80 may include initiating reactivation upon detection of zero power output from batteries 10, 60. For standard AA battery type, one packet of electrolyte mixture 62 is used, and electrolyte solution 26 is enough for multiple activations on multiple batteries. On larger batteries, for multiple activations, more packets may be included. Optionally a specified amount of electrolyte 26 may be different for each batch of reactivation in larger batteries 10, 60. Chelating agent 44 in electrolyte 26 may facilitate the passage of electrons or current through external circuit 38, in activation or reactivation, thereby increasing the efficiency.

### Illustrative Combinations and Additional Examples

This section describes additional aspects and features of apparatus and methods for fluid transport systems, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A battery, comprising:

an anode comprised of magnesium,

a cathode comprised of carbon,

an electrolyte solution comprising water, and an amino acid.

A1. The battery of claim A0, wherein the amino acid comprises glutamic acid.

A2. The battery of claim A0, wherein the amino acid comprises one or more of the following: glutamic acid, aspartic acid, valine, and asparagine.

A3. The battery of claim A0 or A1, wherein the electrolyte solution comprises: glutamic acid in a concentration range of 1% to 11% by weight.

A4. The battery of claim A0-A2, wherein the electrolyte solution further comprises: magnesium chloride.

A5. The battery of claim A0-A4, wherein the electrolyte solution further comprises: alkali halide.

A6. The battery of claim A0-A5, wherein the alkali halide comprises: one or both of lithium chloride and sodium chloride.

A7. The battery of claim A4-A6, wherein the electrolyte solution comprises magnesium chloride in a concentration range of 1% to 6% by weight.

A8. The battery of claim A0-A7, wherein the electrolyte solution comprises: lithium chloride in a concentration range of 1% to 11% by weight.

A9. The battery of claim A0-A8, wherein the electrolyte solution comprises: sodium chloride in a concentration range of 1% to 9% by weight.

B0. A battery kit, comprising:

a battery including an anode comprised of magnesium, and

a cathode comprised of carbon, and

an electrolyte mixture in a container separate from the battery, formulated to activate the battery.

B1. The battery kit of claim B0, wherein the electrolyte mixture comprises: an amino acid.

B2. The battery kit of claim B0 or B1, wherein the electrolyte mixture is stabilized in an aqueous solution.

B3. The battery kit of claim B0 or B1, wherein the electrolyte mixture is stabilized in a dehydrated form until activation of the battery is desired.

B4. The battery kit of claim B0-B3, wherein the electrolyte mixture is contained in a packet.

B5. The battery kit of claim B0-B3, wherein the electrolyte mixture is contained in plural packets formulated for serial activation of the battery over an extended time period.

B6. The battery kit of claim B0 or B1, wherein the electrolyte mixture comprises glutamic acid in an amount configured for hydration to a concentration in a range of 1% to 11% by weight.

B7. The battery kit of claim B0-B6, wherein the electrolyte mixture further comprises lithium chloride in an amount configured for hydration to a concentration in a range of 2% to 11% by weight.

B8. The battery kit of claim B0-B6, wherein the electrolyte mixture further comprises sodium chloride in an amount configured for hydration to a concentration in a range of 2% to 9% by weight.

B9. The battery kit of claim B0-B8, wherein the electrolyte mixture further comprises magnesium chloride in an amount configured for hydration to a concentration in a range of 1% to 6% by weight.

C0. A method of activating a battery, comprising:

storing a dry pre-activated battery including an anode comprised of magnesium, and a cathode comprised of carbon,

activating the battery by adding an electrolyte solution comprising an amino acid.

C1. The method of claim C0, wherein electrolyte solution comprises glutamic acid in a concentration range of 1% to 11% by weight.

C2. The method of claim C0 or C1, further comprising:

hydrating a dehydrated electrolyte mixture prior to the activating step.

D0. A method of configuring a battery system to provide power to an electronic device, the battery system having one or more batteries, each battery including an anode comprised of magnesium, and a cathode comprised of carbon, the method comprising:

maintaining each of the batteries in an anhydrous configuration;

adding an aqueous electrolyte solution to each of the batteries, and each of the batteries attaining a hydrous configuration;

generating power from each of the batteries in the hydrous configuration; and

powering the electronic device with the generated power.

D1. The method of claim D0, further comprising:

preparing an electrolyte solution prior to the adding step.

D2. The method of claim D1, wherein the step of preparing an electrolyte solution includes hydrating a dehydrated electrolyte mixture.

D3. The method of claim D0, wherein the one or more batteries are connected in series.

D4. The method of claim D0, wherein the one or more batteries are connected in parallel.

D5. The method of claim D0, wherein the electrolyte solution comprises magnesium chloride in a concentration range of 1% to 6% by weight.

D6. The method of claim D0, wherein the electrolyte solution comprises: lithium chloride in a concentration range of 1% to 11% by weight.

D7. The method of claim D0, wherein the electrolyte solution comprises: sodium chloride in a concentration range of 1% to 9% by weight.

E0. A method for serial activation of a battery system to provide power to an electronic device, the battery system having one or more batteries, each of the batteries including an anode comprised of magnesium, and a cathode comprised of carbon, the method comprising:

initiating activation of each of the batteries by adding a pre-determined amount of an electrolyte solution,

generating power from each of the batteries,

providing the generated power to the electronic device, and

repeating the initiating activation step upon detection of zero power output from the battery system.

E1. The method of claim E0, wherein the pre-determined amount is dependent on dimension and size of each of the batteries.

E2. The method of claim E0, wherein each of the batteries is maintained in an anhydrous configuration prior to the initiating activation step.

E3. The method of claim E0, wherein each of the batteries attains a hydrous configuration after the initiating activation step.

E4. The method of claim E0, wherein the electrolyte solution includes an aqueous solution of a mixture of alkali halides.

E5. The method of claim E4, wherein the electrolyte solution further includes an aqueous solution of an alkali earth metal halide.

E6. The method of claim E0, wherein the electrolyte solution includes an aqueous solution of a chelating agent.

E7. The method of claim E0, wherein each of the batteries yields at least 2.12 v state of charge at rest.

E8. The method of claim E0, wherein a pair of batteries yields at least 4.12 v state of charge at rest.

E9. The method of claim E0, wherein a pair of batteries yields at least 2.07 v state of charge at rest.

### Advantages, Features, and Benefits

The different embodiments and examples of the magnesium carbon batteries described herein provide numerous advantages over known solutions for rechargeable batteries with extended shelf-life. For example, illustrative embodiments and examples described herein allow for the usage of magnesium batteries for a broader range of products.

Additionally, and among other benefits, illustrative embodiments and examples described herein provide for a shelf-stable electrolyte suitable for use in magnesium batteries.

Additionally, examples described herein allow for extended operation of magnesium batteries with overall higher efficiencies.

Additionally, examples described herein provide for the operation of a magnesium battery based on a shelf-stable aqueous electrolyte.

Additionally, examples described herein provide for the preparation of an electrolyte at a time of need for battery use.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A battery, comprising:
an anode comprised of magnesium,
a cathode comprised of carbon,
an electrolyte solution comprising water, and an amino acid.

2. The battery of claim 1, wherein the amino acid comprises glutamic acid.

3. The battery of claim 1, wherein the amino acid comprised one or more of the following: glutamic acid, aspartic acid, valine, and asparagine.

4. The battery of claim 1, wherein the electrolyte solution comprises: glutamic acid in a concentration range of 1% to 11% by weight.

5. The battery of claim 1, wherein the electrolyte solution further comprises: magnesium chloride.

6. The battery of claim 1, wherein the electrolyte solution further comprises: alkali halide.

7. The battery of claim 6, wherein the alkali halide comprises: one or both of lithium chloride and sodium chloride.

8. The battery of claim 5, wherein the electrolyte solution comprises magnesium chloride in a concentration range of 1% to 6% by weight.

9. The battery of claim 1, wherein the electrolyte solution comprises: lithium chloride in a concentration range of 2% to 11% by weight.

10. The battery of claim 1, wherein the electrolyte solution comprises: sodium chloride in a concentration range of 2% to 9% by weight.

11. A battery kit, comprising:
a battery in a pre-activated anhydrous form including an anode comprised of magnesium, and
a cathode comprised of carbon, and
an electrolyte mixture in a container separate from the battery, formulated to activate the battery.

12. The battery kit of claim 11, wherein the electrolyte mixture comprises: an amino acid.

13. The battery kit of claim 12, wherein the electrolyte mixture is stabilized in an aqueous solution.

14. The battery kit of claim 12, wherein the electrolyte mixture is stabilized in a dehydrated form until activation of the battery is desired.

15. The battery kit of claim 14, wherein the electrolyte mixture is contained in a packet.

16. The battery kit of claim 14, wherein the electrolyte mixture is contained in plural packets formulated for serial activation of the battery over an extended time period.

17. The battery kit of claim 12, wherein the electrolyte mixture comprises glutamic acid in an amount configured for hydration to a concentration in a range of 1% to 11% by weight.

18. The battery kit of claim 17, wherein the electrolyte mixture further comprises lithium chloride in an amount configured for hydration to a concentration in a range of 2% to 11% by weight.

19. The battery kit of claim 11, wherein the electrolyte mixture further comprises sodium chloride in an amount configured for hydration to a concentration in a range of 2% to 9% by weight.

20. The battery kit of claim 19, wherein the electrolyte mixture further comprises magnesium chloride in an amount configured for hydration to a concentration in a range of 1% to 6% by weight.
